(19) United States
(12) Patent Application Publication
(10) Pub. No.: US 2017/0031660 A1
(43) Pub. Date: Feb. 2, 2017

(54) METHODS FOR UTILIZING POWERSHELL MODULES IN .NET APPLICATIONS AND DEVICES THEREOF

(71) Applicant: NetApp, Inc., Sunnyvale, CA (US)

(72) Inventors: Steven Beam, Holly Springs, NC (US); John Fullbright, Evans, GA (US); Glenn Sizemore, Raleigh, NC (US)

(21) Appl. No.: 14/814,672

(22) Filed: Jul. 31, 2015

(51) Int. Cl. G06F 9/44; G06F 9/45

(52) U.S. Cl. CPC G06F 8/315; G06F 8/41

(57) ABSTRACT

A method, non-transitory computer readable medium, and computing device that loads a scripting framework module into a runspace. The module includes a command including a noun, a verb, a parameter set, and a return type of the parameter set. Source code comprising a noun class corresponding to the noun, a build command method in the noun class corresponding to the verb, and a parameter set method in the noun class corresponding to the parameter set is generated. The build command method generates and returns an object and the parameter set method constructs and invokes the command using the build command method and converts a collection of objects returned in response to the command invocation into an enumerable of the return type. The source code, or a proxy dynamic link library (DLL) generated by compiling the source code, is output to an output directory.

### FIELD

This technology relates to performing administrative tasks on computing devices and, more particularly, to embedding PowerShell commands within .NET applications in order to perform administrative tasks.

### BACKGROUND

PowerShell is a command-line shell and scripting language often used by system administrators to facilitate administrative tasks. In the context of data storage networks, specialized commands referred to as PowerShell cmdlets can be used to communicate with storage controllers to automate provisioning of aggregates and volumes in a storage system, monitor and manage snapshots, and manage mirroring and other data protection schemes, among other administrative operations. Accordingly, a hardware provider may provide a library, module, or other set of PowerShell cmdlets, often referred to as a toolkit, that encapsulates application programming interfaces (APIs) in a software development kit (SDK) in order to allow administrators to perform a variety of tasks using PowerShell.

Administrators often develop compiled .NET applications that leverage such toolkits in order to perform administrative and management tasks. However, invoking PowerShell from a .NET application is currently cumbersome and error-prone, particular for many developers of such .NET applications that are often more familiar with C# than with PowerShell conventions and syntax.

As one example, for an administrator to invoke a New-NaVol cmdlet of a PowerShell toolkit from a C# .NET application, a PowerShell runspace must first be established using the Runspace .NET class and a PowerShell module must then be loaded. Next, a PowerShell .NET class must be set up and the desired command and associated parameters must then be added. Finally, the “Invoke” method must be run on a PowerShell object and the results must be collected in a Collection<PSObject>.NET object. In this example, the following source code would be required to run a single PowerShell cmdlet within a .NET application assuming the Runspace is already contained in the runspace variable, and not including source code required to set up the runspace and interpret the results:

PowerShell shell=PowerShell.Create( );
shell.Runspace=this.runspace;
shell.AddCommand(“New-NaVol”);
shell.AddParameter(“Name”, “testvol”);
shell.AddParameter(“Aggregate”, “aggr1”);
shell.AddParameter(“SpaceReserve”, “none”);
shell.AddParameter(“Size”, “50 GB”);
Collection<PSObject>results=shell.Invoke( );

In addition to errors introduced due to the length and complexity of the source code required to invoke the New-NaVol cmdlet in this example, the source code is also relatively prone to error because the command and parameter name values are simple strings that cannot be checked at compile time. Accordingly, any misspellings or other similar errors will result in a code failure only at runtime, rendering the source code and associated .NET application relatively difficult to debug.

### SUMMARY

A method for utilizing scripting framework commands in .NET applications includes loading, by a computing device, a scripting framework module into a runspace. The scripting framework module comprises a command comprising a noun, a verb, a parameter set, and a return type associated with the parameter set. Source code comprising a noun class corresponding to the noun, a build command method in the noun class corresponding to the verb, and a parameter set method in the noun class corresponding to the parameter set is generated by the computing device. The build command method generates and returns a collection of objects and the parameter set method constructs and invokes the command using the build command method and converts the collection of PowerShell objects returned in response to the PowerShell command invocation into an enumerable of the return type. The source code, or a proxy dynamic link library (DLL) generated by compiling the source code, is output, by the computing device, to an output directory.

A computing device includes a processor and a memory coupled to the processor which is configured to be capable of executing programmed instructions comprising and stored in the memory to load a scripting framework module into a runspace. The scripting framework module comprises a command comprising a noun, a verb, a parameter set, and a return type associated with the parameter set. Source code comprising a noun class corresponding to the noun, a build command method in the noun class corresponding to the verb, and a parameter set method in the noun class corresponding to the parameter set is generated. The build command method generates and returns a collection of objects and the parameter set method constructs and invokes the command using the build command method and converts the collection of objects returned in response to the command invocation into an enumerable of the return type. The source code, or a proxy DLL generated by compiling the source code, is output to an output directory.

A non-transitory computer readable medium having stored thereon instructions for utilizing scripting framework commands includes executable code which when executed by a processor, causes the processor to perform steps including loading a scripting framework module into a runspace. The scripting framework module comprises a command comprising a noun, a verb, a parameter set, and a return type associated with the parameter set. Source code comprising a noun class corresponding to the noun, a build command method in the noun class corresponding to the verb, and a parameter set method in the noun class corresponding to the parameter set is generated. The build command method generates and returns a collection of objects and the parameter set method constructs and invokes the command using the build command method and converts the collection of objects returned in response to the command invocation into an enumerable of the return type. The source code, or a proxy DLL generated by compiling the source code, is output to an output directory.

This technology provides a number of advantages including providing more efficient and effective methods, non-transitory computer readable media, and devices for utilizing scripting framework modules, such as PowerShell modules, in .NET applications. With this technology, runtime errors associated with PowerShell embedded into .NET applications are significantly reduced. By this technology, a proxy generator provides relatively familiar semantics and C# syntax for .NET application developers embedding PowerShell cmdlets of PowerShell modules into .NET applications. Accordingly, this technology allows .Net application developers to focus on the business logic of .NET applications rather than the PowerShell interfacing.

### BRIEF DESCRIPTION OF THE DRAWINGS

FIG. 1 is a block diagram of a storage network environment with an exemplary storage network management computing device coupled to a storage controller computing device managing data storage on storage servers;

FIG. 2 is a block diagram of the exemplary storage network management computing device;

FIG. 3 is a flowchart of an exemplary method for utilizing PowerShell modules in .NET applications by the exemplary storage network management computing device;

FIG. 4 is a table illustrating exemplary naming conventions for PowerShell cmdlets;

FIG. 5 is a table of exemplary PowerShell cmdlet verbs and associated usage;

FIG. 6 is a table of exemplary parameter sets and associated parameters for an exemplary PowerShell cmdlet; and

FIG. 7 is exemplary source code illustrating exemplary parameter set methods and exemplary flag enumerations.

### DETAILED DESCRIPTION

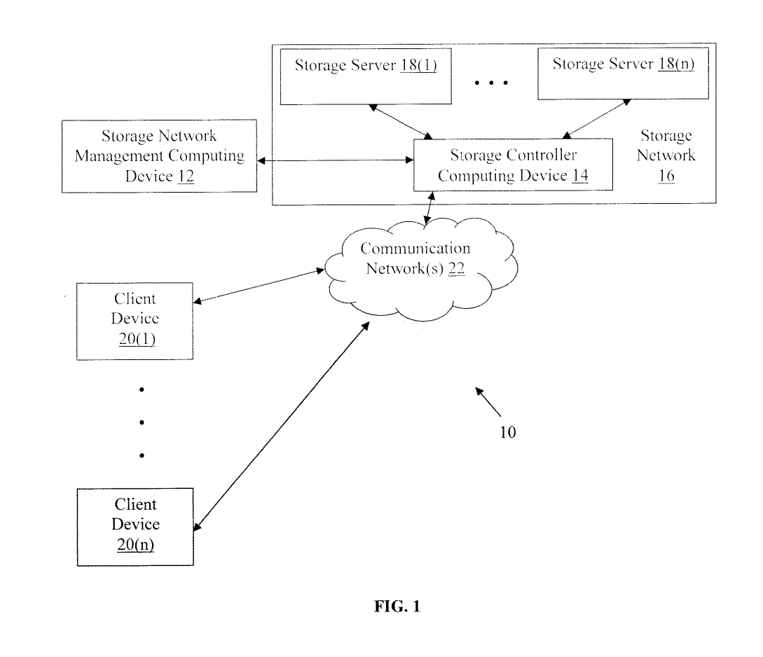

A network environment 10 including an example of a storage network management computing device 12 coupled to a storage controller computing device 14 of a storage network 16 is illustrated in FIG. 1. In this particular example, the storage network 16 further includes storage servers 18(1)-18(n) coupled to the storage controller computing device 14. Additionally, the environment 10 in this example further includes client devices 20(1)-20(n) coupled to the storage controller computing device 14 via communication network(s) 22, although this environment 10 can include other numbers and types of systems, devices, components, and/or elements in other configurations. The client devices 20(1)-20(n) can host applications that utilize the storage network 16 to store back-end data, for example. Accordingly, the storage network management computing device 12 is used to administer the storage network 16, and in particular to manage the storage controller computing device 14, as described and illustrated in more detail later. This technology provides a number of advantages including methods, non-transitory computer readable media, and devices that facilitate relatively efficient utilization of PowerShell modules in .NET applications while reducing runtime errors.

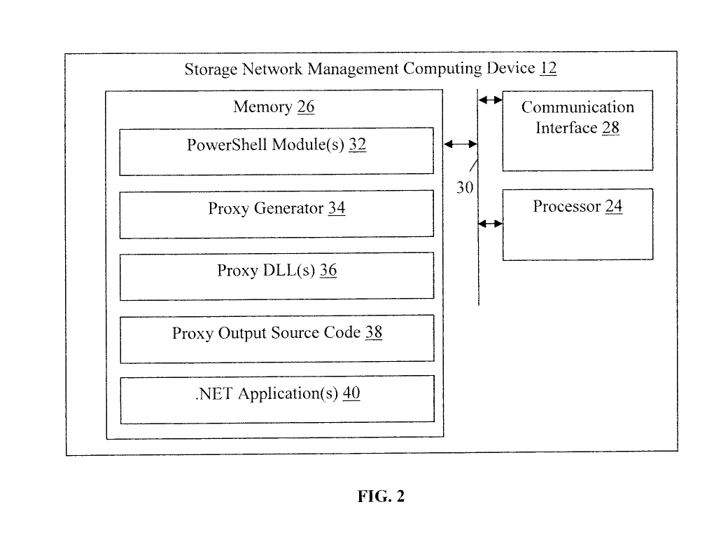

Referring to FIG. 2, a block diagram of the exemplary storage network management computing device 12 is illustrated. In this particular example, the storage network management computing device 12 includes a processor 24, a memory 26, and a communication interface 28 coupled together by a bus 30 or other communication link. The processor 24 of the storage network management computing device 12 executes a program of stored instructions for one or more aspects of the present invention, as described and illustrated by way of the embodiments herein, although the processor 24 could execute other numbers and types of programmed instructions. The processor 24 in the storage network management computing device 12 may include one or more central processing units or general purpose processors with one or more processing cores, for example.

The memory 26 of the storage network management computing device 12 may include any of various forms of read only memory (ROM), random access memory (RAM), Flash memory, non-volatile, or volatile memory, or the like, or a combination of such devices for example. The memory 26 in this example includes PowerShell module(s) 32, a proxy generator 34, proxy DLL(s) 36, proxy output source code 38, and .NET application(s) 40.

The PowerShell module(s) 32 include sets of PowerShell commands also referred to herein as cmdlets, which are lightweight commands that can be invoked to perform actions. One example of a PowerShell module is the Data ONTAP PowerShell Toolkit available from NetApp Inc. of Sunnyvale, Calif. The Data ONTAP PowerShell Toolkit provides PowerShell cmdlets that facilitate automated management of the storage controller computing device 14, and by extension the storage servers 18(1)-18(n), including with respect to storage volume management and data protection, for example, among other administrative functions. The PowerShell module(s) 32 can be loaded, run, and parsed to identify PowerShell cmdlets defined therein, as described and illustrated in more detail later.

The proxy generator 34 is a module, application, or other executable that loads, runs, and parses the PowerShell module(s) 32 and outputs the compiled proxy DLL(s) 36 or proxy output source code 38 that can be used to embed PowerShell code associated with the PowerShell module(s) 32 in the .NET application(s) 40. Accordingly, the proxy DLL(s) 36 are compiled versions of the proxy output source code 38 and are generated by the proxy generator 34. Both the proxy DLL(s) 36 and the proxy output source code 38 are used to facilitate the integration of PowerShell into the .NET application(s) 40, as described and illustrated in more detail later.

The .NET application(s) 40 are developed by administrators to perform management functions with respect to the storage controller computing device 14, such as to implement automated control processing of the storage network 16. The .NET applications can include interfaces to PowerShell, to perform actions corresponding to the PowerShell cmdlets of the PowerShell module(s) 32, which can be optimized according to this technology, as described and illustrated in more detail later.

The communication interface 28 of the storage network management computing device 12 in this example can include one or more network interface controllers (NICs) for operatively coupling and communicating between the storage network management computing device 12 and the storage controller computing device 14, such as by a direct connection or via another communication network (not shown), for example.

The storage controller computing device 14 in this example includes a processor, a memory, and a communication interface coupled together by a bus or other communication link. The memory of the storage controller computing device 14 can host an operating system as well as store instructions that, when executed by the processor, instantiate storage virtual machines, manage volumes, perform backup and other data protection operations, facilitate the storage and providing of data to and from the storage servers 18(1)-18(n), and/or implement other management functions on behalf of the storage network 16.

Each of the storage servers 18(1)-18(n) of the storage 12 in this example includes one or more storage volumes stored in a memory, a processor, and a communication interface coupled together by a bus or other communication link. The storage volumes in this example can be stored on conventional magnetic disks, solid-state drives (SSDs), or any other type of stable, non-volatile storage device suitable for storing large quantities of data. The storage servers 18(1)-18(n) may be organized into one or more volumes of Redundant Array of Inexpensive Disks (RAID), although other types and numbers of storage servers in other arrangements can be used.

Each of the client devices 20(1)-20(n) in this example includes a processor, a memory, and a communication interface, which are coupled together by a bus or other communication link, although each of the client devices 20(1)-20(n) can have other types and numbers of components or other elements. The client devices 20(1)-20(n) can be application servers that host applications executed in a hypervisor, for example, that can utilize the storage network 16 to manage associated data via the communication network(s) 22.

By way of example only, the communication network(s) 22 can use TCP/IP over Ethernet and/or industry-standard protocols including NFS, CIFS, or iSCSI, for example, although other types and numbers of communication networks can be used. The communication network(s) 22 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. The communication network(s) 22 may also comprise local area network(s) and/or wide area network(s) (e.g., Internet), although any other type of traffic network topologies may be used.

Although examples of the storage network management computing device 12, storage controller computing device 14, storage servers 18(1)-18(n), and client devices 20(1)-20(n) are described herein, it is to be understood that the devices and systems of the examples described herein are for exemplary purposes, as many variations of the specific hardware and software used to implement the examples are possible, as will be appreciated by those skilled in the relevant art(s). In addition, two or more computing systems or devices can be substituted for any one of the systems in any embodiment of the examples.

The examples also may be embodied as one or more non-transitory computer readable media having instructions stored thereon for one or more aspects of the present technology, as described and illustrated by way of the examples herein, which when executed by the processor, cause the processor to carry out the steps necessary to implement the methods of this technology, as described and illustrated with the examples herein.

An exemplary method for utilizing the PowerShell module(s) 32 in the .NET application(s) 40 s will now be described with reference to FIGS. 1-7. This technology is described and illustrated herein in the context of managing the storage network 16 for exemplary purposes only, and this technology is applicable for any .NET application that utilizes PowerShell module(s) for any purpose and in any context. Further, while this technology is described and illustrated by way of the examples in the context of PowerShell as a scripting framework, any other scripting framework can also be used. Even further, this technology is applicable for utilization of scripting framework modules in other types of applications in addition to .Net applications.

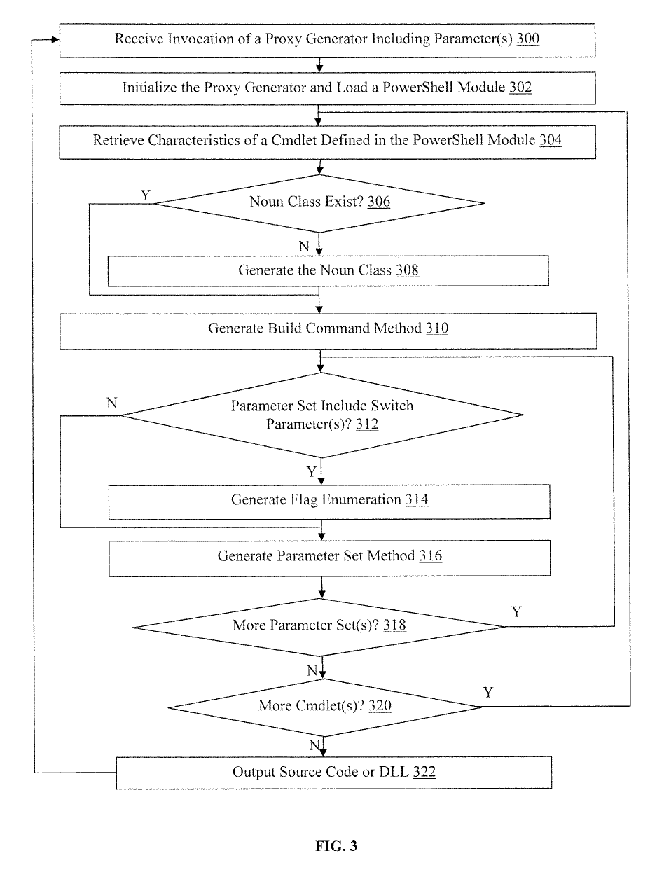

Referring more specifically to FIG. 3, in step 300 in this example, the storage network management computing device 12 receives an invocation of the proxy generator 34, such as via a command line interface. In one example, the invocation can have a “proxygen -m [Module] -o [OutputDirectory] -c [ReferencedAssemblies]” format, although other formats can also be used.

In this example, the proxy generator 34 is invoked with a module parameter, an optional output directory parameter, and an optional compile parameter, although other types and numbers of parameters can also be used in other examples. The module parameter is required in this example and includes the name of, or a path corresponding to, one of the PowerShell module(s) 32 that a developer or administrator wants to utilize in one of the .NET application(s) 40. The output directory parameter includes an indication of a directory in which to place output artifacts, which can be the proxy output source code 38 or one of the proxy DLL(s) 36.

The compile parameter includes a list of assemblies that can be referenced when building one of the proxy DLL(s) 36. Accordingly, if the optional compile parameter is specified, then the output of the proxy generator 34 is one of the proxy DLL(s) 36 and, if the compile parameter is not specified, then the output of the proxy generator 34 executable is C# proxy output source code 38 that can be used to compile one of the proxy DLL(s) 36, as described and illustrated in more detail later.

In step 302, the proxy generator 34 executing on the storage network management computing device 12 initializes the proxy generator 34 and loads one of the PowerShell module(s) 32, such as the one of the PowerShell module(s) 32 identified in the module parameter of the proxy generator 34 invocation. During initialization, the proxy generator 34 creates three classes in C# source code including a main class, a base class, and an exception class in this example.

The main class and its associated constructors are configured to load the one of the PowerShell module(s) 32 in a runspace that is used for all future PowerShell invocations made by a generated Proxy object. The base class in this example facilitates invocation of PowerShell cmdlets and conversion of a collection of PowerShell objects into an enumerable. The exception class in this example defines an exception thrown when an error occurs in an invocation a PowerShell cmdlet by the base class. Other types and numbers of classes can also be created upon initialization of the proxy generator 34 in other examples.

In step 304, the proxy generator 34 executing on the storage network management computing device 12 retrieves characteristics of a cmdlet defined in the one of the PowerShell module(s) 32. Accordingly, the proxy generator 34 in this example can parse the one of the PowerShell module(s) 32 to identify PowerShell cmdlet(s) defined therein and retrieve characteristics of one of the PowerShell cmdlet(s), including a noun, a verb, at least one parameter set, and a return type associated with the parameter set for the one of the PowerShell cmdlet(s). In order to identify the cmdlet(s), in one example, the proxy generator 34 can invoke a “Get-Command” PowerShell cmdlet to retrieve one or more information objects that include data identifying the PowerShell cmdlet(s) in the one of the PowerShell module(s) 32, although other methods for identifying the PowerShell cmdlet(s) can also be used.

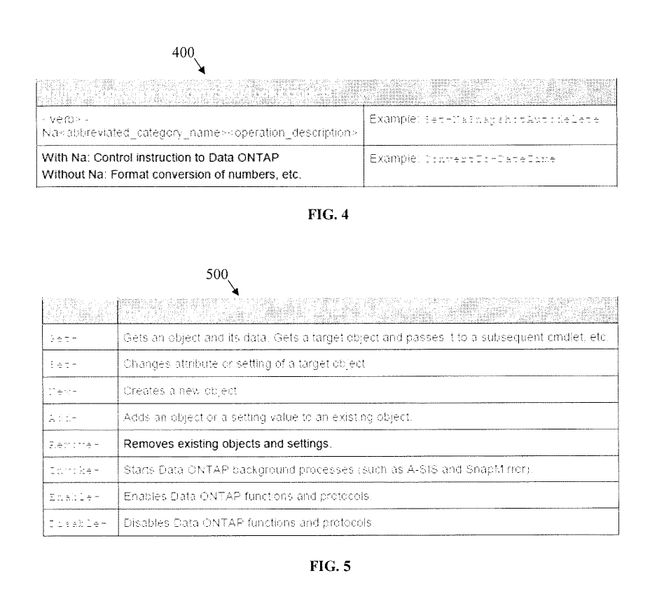

Referring more specifically to FIG. 4, a table 400 illustrating exemplary naming conventions for PowerShell cmdlets is illustrated. PowerShell cmdlets include a noun and a verb separated by a hyphen (e.g., Set-NaSnapshotAutodelete). In this particular example, two naming conventions are illustrated including verbs with “Na”, which represent a control instruction for an operating system of the storage controller computing device 14, and without Na, which represent format conversions. Although all PowerShell cmdlets include a noun and a verb, other naming conventions can also be used.

Referring more specifically to FIG. 5, a table 500 of exemplary PowerShell cmdlet verbs and associated usage is illustrated. In this particular examples, verbs including get, set, new, add, remove, invoke, enable, and disable are available for use in a cmdlet, although other verbs can also be used in other examples. The verbs correspond with usages that enable administrators to control the storage controller computing device 14 or otherwise manage the storage network 16 in this example.

Referring back to FIG. 3, the proxy generator 34 executing on the storage network management computing device 12 determines whether a noun class exists for the noun of the one of the PowerShell cmdlet(s) for which characteristics were retrieved in step 304. In the first iteration, a noun class will not have been previously created and, accordingly, the proxy generator 34 executing on the storage network management computing device 12 will determine that the noun class does not exist and the No branch will be taken to step 308.

In step 308, the proxy generator 34 executing on the storage network management computing device 12 generates the noun class for the noun of the one of the PowerShell cmdlet(s). The noun class holds at least a build command method for each verb included in a cmdlet of the one of the PowerShell module(s) 32 that shares the same noun (e.g., “Get-Foo” and “Set-Foo”) and a parameter set method for each parameter set associated with one of the verbs, as described and illustrated in more detail later. Additionally, the base class created in step 302 provides methods for the noun class to use to invoke PowerShell cmdlets and convert resulting collections of PowerShell objects into enumerables, also as described and illustrated in more detail later.

Subsequent to creating the noun class, or if the proxy generator 34 executing on the storage network management computing device 12 determines in step 306 that the noun class does exist and the Yes branch is taken, then the proxy generator 34 executing on the storage network management computing device 12 proceeds to step 310. In step 310, the proxy generator 34 executing on the storage network management computing device 12 generates a build command method. The build command method uses methods provided by the base class to generate and return a PowerShell object that can be invoked by a caller and used to construct a command corresponding to the one of the PowerShell cmdlet(s), as described and illustrated in more detail later with reference to step 316.

In step 312, the proxy generator 34 executing on the storage network management computing device 12 determines whether one of the parameter set(s) associated with the one of the cmdlet(s), and retrieved with the characteristics of the one of the PowerShell cmdlet(s) in step 304, includes at least one switch parameter. Switch parameters are defined as either present or not present in PowerShell and are passed into a parameter set method in this example as flag enumerations, as described and illustrated in more detail later. Accordingly, if the proxy generator 34 executing on the storage network management computing device 12 determines that one of the parameter set(s) associated with the one of the cmdlet(s) includes at least one switch parameter, then the Yes branch is taken to step 314.

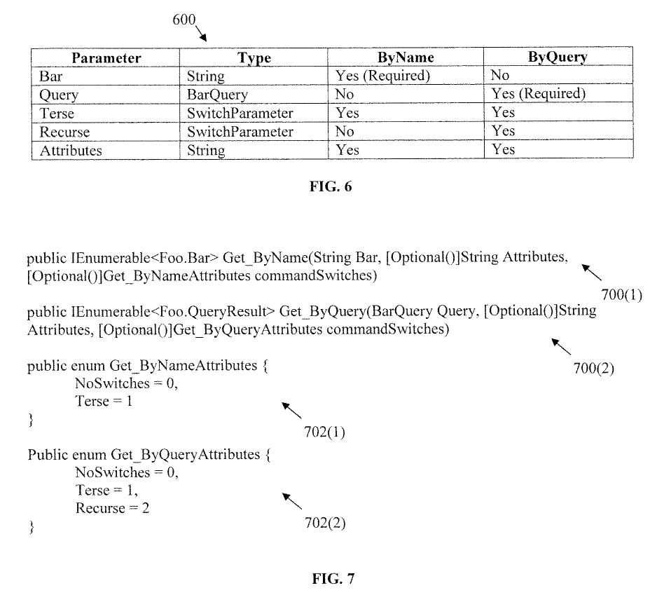

Referring more specifically to FIG. 6, a table 600 of exemplary parameter sets and associated parameters for an exemplary PowerShell cmdlet is illustrated. In this example, the PowerShell cmdlet is “Get-Foo”, wherein “Get” is the verb and “Foo” is the noun of the PowerShell cmdlet. Accordingly, “Foo” in this example is a noun class generated as described and illustrated in more detail earlier with reference to step 308, and “Get” has associated parameter set methods within the “Foo” class that are generated as described and illustrated in more detail later with reference to step 316. In this example, the parameter sets are “ByName” and “ByQuery” and the “ByName” parameter set includes “Bar”, “Terse”, and “Attributes” parameters and the “ByQuery” parameter set includes “Query”, “Terse”, “Recurse”, and “Attributes” parameters. Additionally, the “Terse” and “Recurse” parameters are switch parameters.

Referring back to FIG. 3, in step 314, the proxy generator 34 executing on the storage network management computing device 12 generates a flag enumeration for the switch parameter(s). Referring more specifically to FIG. 7, exemplary source code illustrating exemplary parameter set methods 700(1) and 700(2) and exemplary flag enumerations 702(1) and 702(2) is illustrated. In this example, the flag enumerations “Get ByNameAttributes” and

“Get ByQueryAttributes” are generated for the switch parameters of the “ByName” and “ByQuery” parameter sets illustrated in the table 600 of FIG. 6, respectively.

Subsequent to generating the flag enumeration in step 314, or if the proxy generator 34 executing on the storage network management computing device 12 determines in step 312 that the parameter set does not include any switch parameters and the No branch is taken, the proxy generator 34 executing on the storage network management computing device 12 proceeds to step 316. In step 316, the proxy generator 34 executing on the storage network management computing device 12 generates a parameter set method for the one of the parameter set(s) associated with the one of the PowerShell cmdlet(s) for which characteristics were retrieved in step 304.

The parameter set method for the one of the parameter set(s) is configured to construct and invoke a PowerShell command, using the build command method generated in step 310, and convert the collection of PowerShell objects returned in response to the PowerShell command invocation into an enumerable of a return type corresponding to the return type associated with the parameter set in the characteristics retrieved in step 304. Optionally, the parameter set method has a naming convention that correspond to “[verb] [parameter set name]”, although other naming conventions can also be used.

In the example illustrated in FIG. 7, the parameter set method 700(1) is named “Get ByName” corresponding to the “Get” verb and the “ByName” parameter set illustrated in FIG. 6. Additionally, the method returns an IEnumerable of the type “Foo.Bar” and, accordingly, “Foo.Bar” corresponds to the return type associated with the “ByName” parameter set in the characteristics retrieved as described and illustrated earlier with reference to step 304 of FIG. 3. The parameters of the “ByName” parameter set and, in particular, the flag enumeration 702(1), are also reflected in the parameter set method 700(1).

Similarly, the parameter set method 700(2) is named “Get ByQuery” corresponding to the “Get” verb and the “Query” parameter set illustrated in FIG. 6. Additionally, the method returns an IEnumerable of the type “Foo.QueryResult” and, accordingly, “Foo.QueryResult” corresponds to the return type associated with the “ByQuery” parameter set in the characteristics retrieved as described and illustrated earlier with reference to step 304 of FIG. 3. The parameters of the “ByQuery” parameter set and, in particular, the flag enumeration 702(2), are also reflected in the parameter set method 700(2). Accordingly, in this example, each of the parameter set methods 700(1) and 700(2) and the flag enumerations 702(1) and 702(2) would be placed in the “Foo” noun class generated as described and illustrated in more detail earlier with reference to step 308.

In step 318, the proxy generator 34 executing on the storage network management computing device 12 determines whether at least one additional parameter set was included in the characteristics for the one of the PowerShell cmdlet(s) retrieved in step 304. If the proxy generator 34 executing on the storage network management computing device 12 determines that there is at least one additional parameter set for the one of the PowerShell cmdlet(s), then the Yes branch is taken back to step 312. Accordingly, steps 312-316 are repeated in this example for each parameter set associated with the one of the PowerShell cmdlet(s). However, if the proxy generator 34 executing on the storage network management computing device 12 determines instep 318 that there are no more parameter set(s), then the No branch is taken to step 320.

In step 320, the proxy generator 34 executing on the storage network management computing device 12 determines whether at least one additional PowerShell cmdlet is defined in the one of the PowerShell module(s) 32 based on the parsing of the one of the PowerShell module(s) in step 302. If the proxy generator 34 executing on the storage network management computing device 12 determines in step 320 that the one of the PowerShell module(s) 32 includes at least one additional PowerShell cmdlet, then the Yes branch is taken back to step 304. Accordingly, steps 304-318 are repeated in this example for each of the PowerShell cmdlet(s) defined in the one of the PowerShell module(s) 32. However, if the proxy generator 34 executing on the storage network management computing device 12 determines in step 320 that no more PowerShell cmdlets are defined in the one of the PowerShell module(s) 32, then the No branch is taken to step 322.

In step 322, the proxy generator 34 executing on the storage network management computing device 12 outputs one of the proxy DLL(s) 36, or the proxy output source code 38 that can be used to compile the one of the proxy DLL(s) 36, to an output directory. The proxy output source code 38 that is output, or compiled to generate the one of the proxy DLL(s) 36, includes at least the noun class(es) generated as described and illustrated earlier with reference to step 308, and associated methods, and optionally the classes generated during initialization of the proxy generator 34 as described and illustrated in more detail earlier with reference to step 302.

In this example, the storage network management computing device 12 determines whether the optional compile parameter is present in the invocation of the proxy generator 34 received as described and illustrated in more detail earlier with reference to step 300. If the storage network management computing device 12 determines that the compile parameter was present, then the one of the proxy DLL(s) 36 is output in step 322. However, if the storage network management computing device 12 determines that the compile parameter was not present, then the proxy output source code 38 is output in step 322.

Additionally, the storage network management computing device 12 can output the proxy output source code 38 or one of the proxy DLL(s) 36 to a directory identified by the optional directory parameter included in the invocation of the proxy generator 34 received as described and illustrated in more detail earlier with reference to step 300, if present. In examples in which the directory parameter is not present in the invocation of the proxy generator 34, the storage network management computing device 12 can optionally output the proxy output source code 38 or one of the proxy DLL(s) 36 to a current directory, although other defaults can also be used. Optionally, the storage network management computing device can then proceed back to step 300 and received another invocation of another instance of the proxy generator 34 including parameters identifying another one of the PowerShell module(s) 32.

Subsequent to outputting the proxy output source code 38 or one of the proxy DLL(s) 36, a developer can use the proxy output source code 38 or one of the proxy DLL(s) 36 to integrate cmdlet(s) of the one of the PowerShell modules 32 into one or more of the .NET application(s) 40 and execute the one of the .Net application(s) 40 in order to perform automated management functions on the storage controller computing device 14, for example.

As one example, the following source code would be required in order to invoke the New-NaVol cmdlet of a PowerShell toolkit, as referenced earlier:

VolumeInfo newVol=ontapProxy.NaVol.New(“testvol”, “aggr1”, SpaceReserve: “none”, Size: “50 GB”).First( );”

Accordingly, in this example, the New-NaVol cmdlet is called using less code and as a method on an object (ontapProxy), which eliminates the possibility for runtime errors occurring with respect to the command name string. Additionally, the cmdlet is invoked via a C# .NET method call having a syntax that is relatively familiar to .NET developers, and the parameters for the method are entered into the method call positionally (e.g., “testvol”) or by name (e.g., “SpaceReserve”). Even further, the result of the method call is returned as an enumeration of “VolumeInfo” objects from a namespace included with the toolkit, which is more effectively manipulated within the one of the .NET application(s) 40 than a collection of PowerShell objects.

Accordingly, with this technology, PowerShell modules or toolkits with PowerShell cmdlets can be converted into proxy DLLs or proxy output source code that can be utilized in .NET applications with reduced runtime errors. By reducing runtime errors, .NET applications can be easier to debug with this technology. The proxy output source code or proxy DLLs generated with this technology advantageously replicate the flexibility of PowerShell cmdlets of PowerShell modules using C# .NET code that is relatively familiar to developers. Accordingly, this technology facilitates relatively efficient development of .NET applications with embedded PowerShell.

Having thus described the basic concept of this technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of this technology. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

1. A method comprising:
loading, by a computing device, a scripting framework module into a runspace and retrieving one or more information objects comprising data identifying a command in the scripting framework module, the command comprising a noun, a verb, a parameter set, and a return type associated with the parameter set;
generating, by the computing device, source code comprising a noun class corresponding to the noun, a build command method in the noun class corresponding to the verb, and a parameter set method in the noun class corresponding to the parameter set, wherein the build command method generates and returns an object the parameter set method constructs and invokes the command using the build command method, and the parameter set method converts a collection of scripting framework objects returned in response to the command invocation into an enumerable of the return type; and
outputting, by the computing device, an artifact based on the source code to an output directory.

2. The method of claim 1, wherein the scripting framework module is loaded into the runspace in response to a received invocation of a proxy generator, the proxy generator invocation comprising one or more of a module parameter identifying the scripting framework module, an output parameter identifying the output directory, or a compile parameter, and the method further comprises:
determining, by the computing device, when the compile parameter is present in the proxy generator invocation; and
compiling, by the computing device, the source code to generate a proxy DLL, when the determining indicates the compile parameter is present in the invocation, wherein the artifact comprises the proxy DLL.

3. The method of claim 1, further comprising generating, by the computing device, one or more of a main class, a base class for the noun class, or an exception class, wherein the source code comprises the main class, base class, or exception class and the main class loads the scripting framework module into the runspace, the base class facilitates invocation of one or more other commands and conversion of the object scripting framework objects into the enumerable, and the exception class defines an exception thrown when an error occurs in an invocation of one or more of the other command by the base class.

4. The method of claim 1, wherein the parameter set further comprises a switch parameter and the noun class further comprises a flag enumeration identifying the switch parameter.

5. The method of claim 1, wherein the scripting framework comprises PowerShell and the method further comprises invoking, by the computing device, a “Get-Command” PowerShell cmdlet to retrieve the one or more information objects comprising data identifying the command in the scripting framework module.

6. The method of claim 1, further comprising:
generating, by the computing device, a .NET application that invokes the proxy DLL; and
executing, by the computing device, the .NET application to perform a management task on a storage controller computing device.

7. A computing device comprising:
a memory containing machine readable medium comprising machine executable code having stored thereon instructions for performing a method of utilizing scripting framework commands; and
a processor coupled to the memory, the processor configured to execute the machine executable code to cause the processor to:
load a scripting framework module into a runspace and retrieve one or more information objects comprising data identifying a command in the scripting framework module, the command comprising a noun, a verb, a parameter set, and a return type associated with the parameter set;
generate source code comprising a noun class corresponding to the noun, a build command method in the noun class corresponding to the verb, and a parameter set method in the noun class corresponding to the parameter set, wherein the build command method generates and returns an object the parameter set method constructs and invokes the command using the build command method, and the parameter set method converts a collection of PowerShell objects returned in response to the command invocation into an enumerable of the return type; and
output an artifact based on the source code to an output directory.

8. The computing device of claim 7, wherein the scripting framework module is loaded into the runspace in response to a received invocation of a proxy generator, the proxy generator invocation comprising one or more of a module parameter identifying the PowerShell module, an output parameter identifying the output directory, or a compile parameter, and the processor coupled to the memory is further configured to execute the machine executable code to cause the processor to:
determine when the compile parameter is present in the proxy generator invocation; and
compile the source code to generate a proxy DLL, when the determining indicates the compile parameter is present in the invocation, wherein the artifact comprises the proxy DLL.

9. The computing device of claim 7, wherein the processor coupled to the memory is further configured to execute the machine executable code to cause the processor to generate one or more of a main class, a base class for the noun class, or an exception class, wherein the source code comprises the main class, base class, or exception class and the main class loads the scripting framework module into the runspace, the base class facilitates invocation of one or more other commands and conversion of the scripting framework objects into the enumerable, and the exception class defines an exception thrown when an error occurs in an invocation of one or more of the other command by the base class.

10. The computing device of claim 7, wherein the parameter set further comprises a switch parameter and the noun class further comprises a flag enumeration identifying the switch parameter.

11. The computing device of claim 7, wherein the scripting framework comprises PowerShell and the processor coupled to the memory is further configured to execute the machine executable code to cause the processor to invoke a “Get-Command” PowerShell cmdlet to retrieve the one or more information objects comprising data identifying the command in the scripting framework module.

12. The computing device of claim 7, wherein the processor coupled to the memory is further configured to execute the machine executable code to cause the processor to:
generate a .NET application that invokes the proxy DLL; and
execute the .NET application to perform a management task on a storage controller computing device.

13. A non-transitory machine readable medium having stored thereon instructions for performing a method comprising machine executable code which when executed by at least one machine, causes the machine to
load a scripting framework module into a runspace and retrieve one or more information objects comprising data identifying a command in the scripting framework module, the command comprising a noun, a verb, a parameter set, and a return type associated with the parameter set;
generate source code comprising a noun class corresponding to the noun, a build command method in the noun class corresponding to the verb, and a parameter set method in the noun class corresponding to the parameter set, wherein the build command method generates and returns an object the parameter set method constructs and invokes the command using the build command method, and the parameter set method converts a collection of PowerShell objects returned in response to the command invocation into an enumerable of the return type; and
output an artifact based on the source code to an output directory.

14. The non-transitory computer readable medium of claim 13, wherein the scripting framework module is loaded into the runspace in response to a received invocation of a proxy generator, the proxy generator invocation comprising one or more of a module parameter identifying the PowerShell module, an output parameter identifying the output directory, or a compile parameter, and the machine executable code when executed by the machine further causes the machine to:
determine when the compile parameter is present in the proxy generator invocation; and
compile the source code to generate a proxy DLL, when the determining indicates the compile parameter is present in the invocation, wherein the artifact comprises the proxy DLL.

15. The non-transitory computer readable medium of claim 13, wherein the machine executable code when executed by the machine further causes the machine to generate one or more of a main class, a base class for the noun class, or an exception class, wherein the source code comprises the main class, base class, or exception class and the main class loads the scripting framework module into the runspace, the base class facilitates invocation of one or more other commands and conversion of the scripting framework objects into the enumerable, and the exception class defines an exception thrown when an error occurs in an invocation of one or more of the other command by the base class.

16. The non-transitory computer readable medium of claim 13, wherein the parameter set further comprises a switch parameter and the noun class further comprises a flag enumeration identifying the switch parameter.

17. The non-transitory computer readable medium of claim 13, wherein the scripting framework comprises PowerShell and the machine executable code when executed by the machine further causes the machine to invoke a “Get-Command” PowerShell cmdlet to retrieve the one or more information objects comprising data identifying the command in the scripting framework module.

18. The non-transitory computer readable medium of claim 13, wherein the machine executable code when executed by the machine further causes the machine to:
generate a .NET application that invokes the proxy DLL; and
execute the .NET application to perform a management task on a storage controller computing device.
